(19) United States
(12) Patent Application Publication
(10) Pub. No.: US 2017/0300598 A1
(43) Pub. Date: Oct. 19, 2017

(54) SYSTEM AND METHOD FOR DESIGNING A PRODUCT AND MANUFACTURING A PRODUCT

(71) Applicant: Seebo Interactive Ltd., Tel Aviv (IL)

(72) Inventors: Lior AKAVIA, Tel Aviv (IL); Liran AKAVIA, Tel Aviv (IL); Yarden HOD, Tel Aviv (IL); Ori LAGZIEL, Rosh Haayin (IL); Ido RAN, Rehovot (IL)

(21) Appl. No.: 15/509,863

(22) PCT Filed: Sep. 20, 2015
(86) PCT No.: PCT/IL2015/050952

§ 371 Date: Mar. 9, 2017

Related U.S. Application Data
(60) Provisional application No. 62/052,515, filed on Sep. 19, 2014.

(51) Int. Cl. G06F 17/50; G06Q 50/04; G06Q 30/02

(52) U.S. Cl. CPC G06F 17/50; G06Q 50/04; G06F 17/5009; G06F 2217/12; G06Q 30/0283

(57) ABSTRACT

A system and method for designing and manufacturing products are provided. A system and method may include receiving one or more characteristics of a product; automatically selecting, based on the characteristics, one or more physical components to be included in the product; automatically defining a firmware module configured to interface with the selected physical modules; and automatically generating a set of manufacturing specifications usable for manufacturing the product, wherein the product includes the selected physical components and the firmware module.

### FIELD OF THE INVENTION

The present invention relates generally to designing and manufacturing a product. More specifically, the present invention relates to using high level tools for designing a product and generating manufacturing specifications for manufacturing the product.

### BACKGROUND OF THE INVENTION

Creation of a new technology based product requires interdisciplinary knowledge and vast understanding in various fields, depending on the nature of the new product.

Today's market is divided into companies and individuals with different skills. This division between the different fields of expertise becomes crucial with the introduction of “connected things”, or the Internet Of things (IOT), e.g., as described in http://en.wikipedia.org/wiki/Internet_of_Things. For example, manufacturers typically have vast knowledge related to manufacturing physical products, and are very familiar with the mass production process, including estimated costs, materials to be used and optimal design. However, manufacturers typically lack the knowledge related to software application development, electronic circuits and other technologies. On the other hand, software application developers usually have a vast knowledge about software and application design, code architecture, servers' integration and analytic systems, but lack knowledge required for creation of physical products and manufacturing the products in mass production.

Accordingly, one who specializes in one field needs many other specialists in order to complete the flow from an idea to a product that is manufactured, e.g., in mass production. For example, electronic engineering, firmware programming, printed circuit board (PCB) design and manufacturing and cost estimation may all be required in order to mass produce a product based on an idea, characteristic or concept.

### SUMMARY OF THE INVENTION

A system and method for designing and manufacturing products are provided. A system and method may include receiving one or more characteristics of a product; automatically selecting, based on the characteristics, one or more physical components to be included in the product; automatically defining a firmware module configured to interface with the selected physical modules; and automatically generating a set of manufacturing specifications or instructions, usable for manufacturing the product, wherein the product includes the selected physical components and the firmware module.

A system and method may include generating a software development kit (SDK) module configured to interface with the firmware module, the SDK module usable by an application developer for developing a software application for the product. A system and method may include providing a graphical user interface (GUI) that enables a user to graphically perform at least one of: add a physical module to the product, remove a physical module from the product and position a physical module on the product.

A system and method may include a simulation engine configured to simulate at least one of: an input to the selected physical modules, an output from the selected physical module, an environmental condition, a physical condition of the product, an interaction between different physical modules and an interaction of a user with the product; and using the simulator engine to simulate a behavior of the product. A system and method may include, while simulating a behavior of a product, graphically presenting input or output data of the physical modules.

A system and method may include selecting, based on a set of characteristics, at least two different alternative sets of physical modules to be included in the product; generating at least two alternative designs for the product based on the selected sets; and ranking the at least two designs based on a set of criteria. A system and method may include calculating a production cost for a product based on a set of selected physical modules. A system and method may include embedding a unique identification value in each firmware module included in each respective manufactured real product.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to embodiments of the present invention;

FIG. 2 shows a flowchart of a method according to an embodiment of the present invention;

FIG. 3 shows a flow and components of a system according to an embodiment of the present invention;

FIG. 4A shows an exemplary screenshot according to an embodiment of the present invention;

FIG. 4B shows an exemplary screenshot according to an embodiment of the present invention;

FIG. 4C shows an exemplary screenshot according to an embodiment of the present invention;

FIG. 4D shows an exemplary screenshot according to an embodiment of the present invention; and

FIG. 4E shows an exemplary screenshot according to an embodiment of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As discussed, in order to mass produce a product based on high level characteristics, concept or idea requires a number of expertise and capabilities that are typically not possessed by an individual, company or organization. For example, to mass produce a toy that can interact with a child or move by itself, or in order to mass produce a surf board that includes electronic circuitry that can monitor or control the surf board, one needs the know-how in engineering, market research, product development, industrial design, materials and cost estimation, sourcing of factories, distribution and logistics. Similarly, to write or produce a software application is also a complicated task, which requires knowledge and skills in at least the following areas:

software development; game design; game engines; server development; user interface (UI); user experience (UX); animations and design; servers; and analytic systems. Software applications with the ability to control, monitor or interact with physical products are becoming the reality of the current market. However, these barriers mentioned above make it difficult for manufacturers, factories, app developers and/or designers to produce such products, and require difficult and long interdisciplinary production process. These factors make the current products expensive and hard to develop.

Historically, most companies used to separate these fields, and buy the required components from third parties. For example, today's computers market is separated between basic hardware (HW) materials providers (such as Intel), product providers (such as IBM), operation system (OS) providers (such as Microsoft), and applications/app providers (such as Skype). However, these companies focus on computers which are very complex and specific products, while the IOT focuses on making daily connected products that may involve for example, fashion designers, watches manufacturers, toy companies, bags factories and the like.

In accordance with the examples above, an IOT bag may include a GPS that sends a message to his user's smartphone indicating its location in an airport; a smart shoe may track the number of paces and speed of a user, and allow him to monitor his daily activity through an application and the like. All of these products require product design, hardware engineering, firmware, a dedicated software application, connectivity module between the software and the firmware, interface between firmware and software, data analysis, application development, physical product production and costs (plastics, fabrics, metals) and hardware manufacturing and costs.

As described herein, embodiments of the invention solve the need for a user or company to have, buy or possess all required know-how. For example, a system and method according to the invention include a technological product builder (TPB) that receives a characteristic or concept of a product and, automatically: selects one or more physical modules to be included in the product; defines a firmware module adapted to interface with the selected physical modules, and generates manufacturing instructions or specifications for mass production of the product. A TPB system as referred to herein may be, or may include components of a computing device. For example, a TPB system may be a unit, a module and/or a computing device such as computing device 100 described herein. A TPB system may be or may include units or modules, e.g., a chip that includes a controller and a memory with instructions as further described.

According to some embodiments of the invention, a TPB system may be configured to allow corporates and/or individuals who have an idea for a technology based product that contains hardware or physical modules or components, to plan and execute their products or prototypes and proceed to mass production of the technological product with ease, in an efficient and productive manner A product as referred to herein may include hardware or physical modules, e.g., a bubble level, a gyroscope. A product as referred to herein may include hardware or physical modules or components such as electronic circuits, firmware and software applications. For example, a product designed and manufactured according to embodiments of the invention may include a power source (e.g., battery); buttons that switch on or off electrical components (e.g., light emitting diodes (LEDs), heat, pressure or other sensors, and so on.

As described, a system and method according to some embodiments of the invention may enable companies or individuals who have an idea to create an electronic based product, to plan prototypes, and/or plan the whole production process, connect with different parties and carry a product from an idea or concept to a supply to retailers.

According to some embodiments of the invention, a system and method may include a production planning sub-system (PPS) that may control and supervises a production of a product in mini scales and in mass scales productions.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

A system and method according to embodiments of the invention may include two different parts: the first part may be configured to assist a user to go from idea to prototype, and the second part may be used to help the user to go from prototype to mass production, in contrast to most platforms available today that only offer software services, ignoring other aspects of the product. Using known systems and methods, there is no one single solution for the prototyping process and the product-building process, which is sometimes crucial. The hardware planning affects the software possibilities and the software plans affect the hardware planning. The product appearance also affects the hardware cost, and the target price affects the offered solutions, both on the hardware and product, and may eventually affect the software needed for such a product.

The targeted costs might be reduced by finding a low cost factory, but also by changing the electronic components, changing the technological solution and/or changing the physical product design. These are all factors that need to be taken under consideration when planning a mass production product, and none of the existing solutions available in the market take care of all of these factors. For example, identification of motion can be obtained by using a tilt sensor, accelerometer, gyro, compass, visual recognition, or by combination of these sensors. Each of these solutions has its own advantages and disadvantages (cost, functionality, physical constraints and more).

Although some companies do offer professional services, these are non-efficient solutions to the problem, since they require human resources and professional support, and are not really a simple technological platform solution.

The solution provided by embodiments of the invention focuses on the whole process, and offers, as mentioned above, a fully automated or semi-automatic solution to the multiple components problem. Using a system and/or method according to embodiments of the invention, a company will be able to work almost independently on its new technological product, thus a system and/or method according to embodiments of the invention enables an easy to use platform for creating electronic products, technological products, Internet of Things (IOT) products, and connected products (product that are able to connect to smart devices. Smart devices are defined as any electronic device having the ability to connect to peripheral devices by wired connection or wirelessly, and allowing an installation of a software application (app). Examples of such devices are smartphones, tablets, smart TVs, PCs, smart watches and the like).

A TPB system described herein may make the technological invention and progression easier for companies, which in turn will create smarter products for the end user.

An example for such a product may be a smart connected doll. In such example, a toy company who has an idea to create a smart doll usually lacks the knowledge for creating the right hardware and firmware for it to operate with a software application. The company may also know what should be the price for such doll, but lacks the knowledge what can be done within this price. They may also lack the knowledge of how to plan the physical doll with the hardware inside, how to implement the hardware properly without disturbing its function, and what can be done in the dedicated app. Sometimes, few algorithms may be required in order to make the data coming from the hardware easy to develop, and specific features may require extra amount of time to be developed. With the TPB system of the invention, the toy company will be able to solve these gaps simply and automatically.

In general, the TPB may be configured to allow users to start a new technological product following just an idea, and learn how to design a product in a step by step method. Users may decide if they want to use some parts of the system, or use the system as a whole, according to their knowledge and level of expertise in every subject. They may further upload an “already-made” project, in cases in which they have partial knowledge and they already started developing technological product without the system, and they may use only specific features for finalizing their initial work.

A system and method according to embodiments of the invention may include, or be divided into, a number of components, e.g., a products components simulator, an SDK, a hardware planning component, an application planning component and a behavior simulator.

A system according to embodiments of the invention may include a products components simulator. The products components simulator may allow users to try out all the electronic components in the system, and see what they do. Using a system according to embodiments of the invention, users may be able to choose the electronic parts according to their planned interaction with the physical product. Using a system according to embodiments of the invention users may be able to choose a component and “try it out” watching a simulation of its possible functions. They may further be able to address the system differently, and sort the components according to the required function.

For example, a user that decided to develop a connected shutter, may desire to find a component that identifies light from the outdoors, and make the shutter open when the component identifies light. Therefore, using a system according to embodiments of the invention, the user may sort the components by the function: “light sensor”, and get to the recommended components. Then, using a system according to embodiments of the invention, the user can start trying them out in the simulator, to get a sense of the differences between them, in order to choose the component that best suits his needs.

Using a system according to embodiments of the invention, users may further design the location in which the components will be located on the physical product in the simulator. When doing so, the system will provide a rough estimation and simulation of the exact functionality expected based on the exact location of the component. In the above example with the shutter, the user may locate the sensor on the upper part of the shutter, or on the inner part of the shutter, and the user may get a different range of light identification for each location. Users may also get different results if they locate more than one sensor or combinations of different sensors. A method and system according to embodiments of the invention may include a simulator that may allow users to examine these factors for each component and for the integration of these components in the planned technological product, thus helping or enabling them to plan the final physical product in a very short time using minimal efforts and costs.

In some embodiments, a system may also allow the user to upload a picture or a 3d model of the physical product, and to design the components according to the real dimensions of the product and the components. Users may be enabled to customize their components according to size and shape, and to evaluate the distance between required components. This may automatically affect their presented cost, as described in details below. For example, a 3D image, a data sheet or any other relevant data may be used to generate a virtual product as described herein and virtual components may be then added to, or included in, the virtual product. Manufacturing instructions (e.g., as used by a factory) may be generated based on a virtual product that includes virtual components and a real product may then be manufactured based on manufacturing instructions.

The phrase “virtual component” as used herein may relate to any digital information related to a physical, real or actual component. For example, a virtual component may include, or may be, content in files stored in a database. A virtual component may be stored in a database in storage 130. In some embodiments, a virtual product may include virtual components.

A system and method according to embodiments may continuously update its database of virtual components. For example, an analytics system may analyze information (e.g., on the internet or as published by manufactures of components) in order to evaluate and re-evaluate components. For example, information related to components such as: performance; cost; quality; mean time between failures (MTBF) and the like may be collected from any relevant source and may be used to update a database of virtual components. Accordingly, problematic components may be avoided and the best components may be chosen for inclusion in products designed and manufactured using a system and method according to embodiments of the invention. Components (or their respective virtual components) may be scored as described according to various criteria and according to information and data gathered as described. For example, an article describing faults in a component may cause a TPB system to automatically lower the score of the relevant virtual component such that it may not be selected. Similarly, an increase of a price of a component may cause its score to be altered.

In some cases, users may not know exactly what components or features they would like to use, and would like to explore the system for functional possibilities. In Such scenario, they may “try out” various components of a system over the simulator in order to learn about the different abilities offered by each one of the components.

According some embodiments of the invention, a product components simulator may include and simulate input elements such as: buttons; pressure sensors; touch sensors; odor sensors; distance sensors; temperature or heat sensors; acceleration sensors; motion sensors, humidity sensors; sound sensors; image sensors; light sensors, proprietary hotspots and tags sensors, Radio-frequency identification (RFID) sensors; other object identification sensors, electrodes; skin conductance sensing component; heart-rate sensors; three dimensional (3D) camera and other input components, and any combinations thereof.

According to some embodiments of the invention, a product components simulator may include and simulate output elements such as: LEDs; buzzers; speakers, screens, motor engines and other output components, and any combinations thereof of input and/or output sensors.

According to some embodiments of the invention, a product components simulator may include and simulate power elements such as: CR2032, 2*AA, 2*AAA, 4*AA, Lithium, USB/Micro USB and the like.

According to some embodiments of the invention, a product components simulator may include and simulate communication components or elements such as: Bluetooth low energy (BLE); Bluetooth2; WiFi; Wired connection and the like.

According to some embodiments of the invention, a product components simulator may determine, identify, include or simulate a hardware structure, for example, a product components simulator may recognize or identify wired and wireless elements or components.

A system and method according to embodiments of the invention may include planning of a PCB, inclusion and/or placement of micro controllers, wiring, and other components or designing a completely working electronic circuit.

A method and system according to embodiments of the invention may include a visual recognition simulation (for example, recognition achieved by a smart device's camera), voice recognition simulation, touch screen simulation and more.

It should be clear that the TPB described here is not restricted to the above mentioned components. Additionally, each component may be used alone, with other components or with new components that may be integrated into a system in the future. For example, identification of motion as described above can be improved by using 2 or more components together, such as accelerometer and a gyro. A TPB may allow these components to be used separately or together, and get different results according to the final configuration. New components known in, or introduced to, the art may be added to the system as independent components or as dependent in other components, according to their accepted performance. For example, new virtual components may be added to a database as new components are introduced by manufacturers of components. For example, when a new motion detection device, component or unit is introduced to the market, a new virtual component that represents the new motion detection device may be included in a database of virtual components as described herein.

The components simulator purpose is to help the user integrate new components into its technological product, try them out and simulate their use, and get cost estimation for the components composition and required hardware and firmware in order to make them work together. For example, using more than 5 LEDS on the same product might require higher power consumption, and this may be achieved only with a better power consumption component that might increase the price. They may also require a larger PCB. These calculations will be done automatically in the TPB system. This part of the system is further described below.

According some embodiments of the invention, a product components simulator may be configured to allow a free play with the components, but may also give warnings and alerts about requirements that the designed system should have. For example, if the warnings are enabled, a product components simulator may not allow the user to forget adding a power source unit to the product and other crucial components required for proper operation of the product. A method and system according to embodiments of the invention may generate an alert based on events, conditions or criteria such as: a need for higher power supply or consumption, a need for a bigger memory chip, a need to add an extra chip, a wiser planning of the hardware structure, location of components, etc. In cases in which the user already has an initial product, the user may integrate the new component he would like to add with his existing system, and watch the results on the screen.

A TPB according to some embodiments of the invention may simulate a component's behavior, provide costs estimate and offer functional possibilities of what to do with the budget. For example, when picking an accelerometer sensor, a system according to some embodiments of the invention may determine and show or display the component's expected cost (e.g. 0.3$-0.8$), and a simulation of the accelerometer movement may be presented (for example, when integrated into a product, the product's acceleration on the 3 axes may be shown on screen by a simulator). In this example, the user may be able to move the product around on the screen, and see the data coming from the accelerometer simulation on screen. In addition, a system according to some embodiments of the invention may suggest or offer cheaper/better alternatives for movement detection (for example, a system according to some embodiments of the invention may offer a gyro unit based on the word “acceleration” in an idea or concept of a product). A user may be enabled to watch a simulation of the alternative component, and decide if it answers his requirements.

A system and method according to embodiments of the invention may also recommend a component according to the user's requirements. For example, searching for a component that identifies “touch” might result in a different component than searching for a component that identifies “pet” or “push”. For example, the word “alarm” in an idea or concept for a product may cause a system and method to select or suggest a simpler component than the one suggested or selected based on the word “music” in an idea, concept or specification of a product. The user may also be able to choose a more specific component after the initial choice by the system. For example, he may choose a monochromatic screen, versus a polychromatic screen, according to his personal needs. He may also watch each of these components' functioning through the simulator. Simplification of electric components by a system and method according to some embodiments of the invention may help product designers, producers and other parties who have little information about electrical engineering, to build and plan a smart product with ease.

A product components simulator according to some embodiments of the invention may include an option to generate and see sample projects, which use the existing components, and see how the components are used in order to understand the component better and be inspired by them. According to some embodiments of the invention, sample projects may include different hardware architectures, cost estimation for the whole project, and 3D designs of the physical sample product.

According to some embodiments of the invention, in sample projects of an IOT and/or connected products, a simulator may include an extra illustration of the software application which comes with a sample product. These sample projects may further include an open source code that can be viewed in a simulator.

According to some embodiments of the invention, a simulator may include an application simulation for each electrical component. For example, the above mentioned accelerometer may have a simulation of the gestures received, and this may further be accompanied by a software application showing an image and/or animation and/or sound and/or of the application's functionality.

For example, a product may be a watch comprising an accelerometer. When moving the hand up and also moving the watch up, different acceleration data may be received, algorithms may be developed in order to analyze the data, and eventually a software application might receive an instruction that the movement “UP” was executed. The software application, in turn, may receive the input and send back a reaction, such as changing the presented hour on the clock to a different time zone, adding animation on a smart device or even connecting to a far computer. These are all examples to specific function that a software application may do with the information received from a physical component included in a physical product. Endless options are available for software application designers based on information received from physical components included in a physical product.

According to some embodiments of the invention, a simulator may enable an easy and automated way to add electronic or other components to a physical product, and get an automatic and fast feedback of possible implications and applications of the integrated components to the physical product.

According to some embodiments of the invention, a TPB system or method may be executed on different devices and/or operating systems (Oss), such as, but not limited to, computers, smartphones, tablets and smart TV's. A system and method according to some embodiments of the invention may save a history of a project for next versions; allow or enable multiple users to work on the same project; track changes from last visit in the system; record sessions on the simulator, allow a demonstration of a concept and/or a tutorial and/or create a specification for potential developers.

According to some embodiments of the invention, a simulator may allow the user to use a virtual demo of a physical product, whether by using a mouse on a computer or using touch on a touch screen, to simulate an activity or behavior of the physical product by a simulator (e.g., a movement, touch, turn on lights, etc.). According to some embodiments of the invention, a simulator may enable a user to watch the possible results in the application simulator. For example, using a system according to some embodiments, the user may put (e.g., using drag and drop as known in the art) a piezoelectric sensor on a simulation of the product, and then touch it virtually. When the piezoelectric sensor is touched (e.g., clicked on in a simulation), an application simulator according to the invention may show the corresponding reaction produced by the simulated sensor and or by a software application that receives input from the simulated sensor.

According to some embodiments of the invention, a simulator may enable the user to change a threshold, range or other parameter in an algorithm that uses input from a sensor, accordingly, a user may play with the parameters and see the results on the screen.

According to some embodiments of the invention interaction with a simulator may wear different forms, as mentioned above, such as using a mouse to control the simulator, using touch on a touch screen, or even using other forms of interaction.

A simulator according to some embodiments of the invention may have different embodiments for different devices and OSs, for example, interaction mediated by wearable devices (such as controllable connected glove or glasses), voice recognition (e.g., “Shake the product!”) or other future useable platform.

According to some embodiments of the invention, an SDK may be automatically generated for a project or product. According to some embodiments of the invention, an automatically generated SDK may include hardware, firmware and software application programming interface (APIs). In some embodiments, an SDK may be pre-generated and may be configured based on a project or virtual product. For example, a generic SDK may be used for all products and the generic SDK may be configured or modified according to a specific product. For example, APIs may be added to a generic SDK such that it is suitable for a specific product.

Once the hardware design is implemented for a physical product, the API component may be implemented inside a simple software application, thus connecting it with the product. According to some embodiments of the invention, a simple software application may be developed without any special concerns about the connection to the hardware, error handling and/or data processing. According to some embodiments of the invention, a software application may be able to connect to the hardware with ease through an automatically generated or updated SDK, thus making the process of creating a real connected product shorter and easier for developers.

According to some embodiments of the invention, configuration in an SDK may perform an automatic update with a TPB system in every activation of the application, and vice versa, e.g., an automatic check of the configuration in the application may be operated each time a user launches the TPB and if there is a newer configuration, an alert may will be generated, accordingly, in some embodiments of the invention, every change in each of these platforms may be documented through a cloud server, to avoid situations in which the project is incongruent on both platforms (e.g., two different hardware structures are requested for the same project). This feature might be expended in some cases to other properties of the project which seem incongruent between the SDK and the TPB, such as different algorithm files chosen, different power consumption solution, different software architecture and the like. A system and method according to some embodiments of the invention enable a user to choose to ignore some or all alerts, e.g., through user settings, preferences or configuration in a TPB.

Accordingly and as further described herein, in order to develop a software application for a product, a developer (e.g., a software engineer) does not need any knowledge or background in hardware, hardware design, hardware integration and the like. As described herein, a system and method according to embodiments of the invention may provide a developer with hardware and with all the necessary software (e.g., in an SDK and firmware as described) so that the developer can develop the application using a high level tools. For example, when developing an application that works with a connected product, a developer does not need to deal with analyzing signals received from sensors or deal with interfacing hardware components. For example, to read values from a sensor, all a programmer needs to do is use an API included in an SDK produced and provided as described. Similarly, configuring, activating or resetting hardware components may be done using APIs provided in an SDK as described.

According to some embodiments of the invention, a TPB may perform, generate, produce, save, display or present a hardware planning for a product. For example, after the users have finished planning their product, a TPB system is configured to allow them to order a physical prototype, and/or a production plan, and/or mass production through the automatic system. For example, after the users have finished planning their product, a TPB system according to some embodiments of the invention may be configured to enable a user to order a physical prototype. A TPB system according to some embodiments of the invention may generate, save and/or present a production plan. For example, a TPB system according to some embodiments of the invention may automatically generate a set of manufacturing instructions, usable for manufacturing the product, e.g., in mass production plants as known in the art.

Some embodiments may be used for rapid prototyping. For example, any number of rounds or iterations may be done where, in each round, a prototype is produced. In some cases, the same SDK and/or firmware module may be used in two or more prototypes. Accordingly, rapid prototyping may be enabled by embodiments of system and/or method according to the invention.

According to some embodiments of the invention, a prototype that may automatically connect to a TPB and SDK, thus when a user or software application developer gets a prototype, it will automatically or seamlessly work with his application, under the condition that he integrated the SDK with his code. In some embodiments, an SDK, as described above, may be generated, downloaded or otherwise obtained from a TPB. Therefore, once a planning stage is over, users might get a customized, ready-to-use prototype “by the click of a mouse”.

In the case of production plan, a system according to some embodiments of the invention may generate, present or offer cost estimation for the electronic parts and physical components which were included in a product, e.g., using a TPB system as described. A cost estimation may be calculated automatically by a system according to some embodiments of the invention, e.g., according to, or based on, collected data from relevant factories and/or producers partners around the world.

Algorithms used by a system according to some embodiments of the invention for cost estimation may include, but are not limited to: cost of electronic components; printed circuit board (PCB); costs; costs of wires; power consumption solution costs; labor costs; overhead costs; regulations costs; logistics & shipment costs and more.

Accordingly, a cost may be calculated by a system and method of the invention based on characteristics, concept or idea received from a user. As described, many designs for a product may be possible (e.g., based on components included in the product), accordingly, a system and method may present a range of designs that may be associated with a respective range of costs. For example, a TPB may present to a user a set of designs for a product where the set is sorted according to cost.

A system and method according to some embodiments of the invention may enable a user to change his or her important parameters for the costs (such as: production country, distribution countries, PCB size limit, specific requirements etc.). For example, parameters, definitions or values for aspects such as production country, distribution countries, PCB size may be selected using a menu or a text box in a TPB system as described. A cost estimation may be generated as described by considering all the user's customized factors.

According to some embodiments of the invention, automatically calculating product costs, may include, or be based on, materials and processes costs, packaging costs, labor costs, and the like, and costs that come from the combination of the physical product and the hardware planning, such as the cost of a uniquely shaped PCB (e.g., designed to allow the hardware to enter the physical product with ease), wires length etc.

A system and method according to some embodiments of the invention may enable a user to limit the expected retail price of the designed product, or insert a goal for profit (e.g., gross/in percentage). The system may further allow users to calculate back the amount they can invest in the hardware, and thus to automatically pick components that can fit the cost requirements. For example, a system and method according to some embodiments of the invention and may receive goals from a user (e.g., cost of manufacturing, profit and the like) and may generate an alert if the goals are not met (e.g., costs are too high for the expected retail price). A system and method according to some embodiments of the invention may mark or indicate (e.g., by highlighting) the most expensive features or component in the product or production plan.

Therefore, users may be able to use a system and method according to some embodiments of the invention in order to change specific components in a product in order to optimize specific parameters, and make real decisions about the final hardware. Accordingly, a system and method according to some embodiments of the invention may simplify the process for laymen, reduce the complexity of the IOT product planning and allow the transparency needed for users to make decisions and create complicated products with ease.

A system and method according to some embodiments of the invention may include sorting components included in a product based on various criteria, parameters or other input received from a user. For example, a system and method according to some embodiments of the invention may include sorting from the most expensive to the cheapest (for example, in order to reduce the cost), from the biggest to the smallest (for example, in order to reduce the size) and the like.

A system and method according to some embodiments of the invention may sort or group the components in a product to sub-categories, open a window with extended details about certain components, or automatically search for cheaper alternatives for each component. Such features and tools in a system and method according to some embodiments of the invention further allow easy planning for laymen.

After finalizing the whole planning of the product, a user may order his mass production through using a system and method according to some embodiments of the invention. A system and method according to some embodiments of the invention may provide access to an automatic order from factories which are connected to the system. For example, a system may automatically send orders or costs estimation requests to factories in a list and receive production offers for a product. A TPB system according to some embodiments of the invention may include an option to generate, store, send or present production files that include the bill of materials (BOM) and schematics as known in the art.

A system and method according to some embodiments of the invention may include (or insert) a unique identification parameter, code, serial number, value or other object into each and every product being manufactured, e.g., in mass production. An identification code included in a product may be encrypted. For example, a unique identification parameter may be included in firmware of the product and may be automatically generated such that it is different for each unit produced.

According to some embodiments of the invention, the unique identification in the firmware may be automatically included in (or made known to) an SDK, accordingly, a unique identification may be used by some embodiments as a security mean. For example, a software application written using the SDK and including unique identification may connect only with products with the same unique identification in their firmware.

Accordingly, other software application developers that may try to develop an application, and connect it to the physical products, will not be able to connect to it without the (possibly encrypted) unique identification, and vice versa, e.g., a physical product will not be able to connect with an application without the unique identification. In another aspect, a unique identification code may be used to increase security of a product thus the end user may benefit from the unique identification code. For example, a unique identification may be used in order to prevent malicious software (e.g., a virus) from installing itself in a product. For example, a software verification process may use a unique identification code in order to enforce security aspects in a product as known in the art.

Products produced in mass production based on a TPB system as described may automatically and seamlessly integrate or work with an SDK generated by the TPB. Thus, physical products which will come out of the mass production, will readily work with a matching application (developed using the SDK) without any further work or effort being required.

Therefore, prototypes and the mass production products may all work, integrate or communicate with a software application. For example, due to the fact that the SDK used by the software and the physical products were both planned over the same tool (e.g., the TPB system described herein), and the system may automatically update the SDK and the physical product with any change made. Therefore, a TPB system dramatically decreases the gap between the initial prototype and the final product as seen using known system and methods.

In some embodiments, The TPB system may allow a schedule planning for mass production, and ordering the right minimum order quantity (MOQ) in order to lower the price. The system may also supply an automatic estimation or a default value of the required MOQ, in order to calculate it with the costs.

A system and method according to some embodiments of the invention may enable or assist a user to plan a software application. For example, a TPB system may allow users to plan an application that will accompany the physical product. For example, a doll may require a dedicated software application which controls the doll's behavior, controls the mechanics and output signals and processes the data of the input signals. In another example, a smart car may require a navigation software application configured to connect the speed bar and gas tank, and to indicate where the closest gas station is. In yet another example, a smart electric stove may need to connect to a software application to set the temperature and timings of activation, or a door bell may need a software application to set the music it plays or alert to the user's smartphone when someone is at the door. Many more examples can be found for smart & connected products which require a software application.

In all the above cases, after planning the hardware and the mass production prototype, or even in the middle of the process, there is a need to plan the software application that goes along with the physical product. The software application which is becoming a crucial part of our everyday products adds another layer of complexity, and sometimes may not be easy to develop.

A software application for this kind of products may include, but is not limited to: a game application, a functional application, services, setting or configuration tools, and more. A software application for this kind of products may also require massive planning of different layers inside the application, and/or require different software tools, such as game engines, servers, analytic system, native extensions, added algorithms and functions, global positioning system (GPS) analyses, touch events, animations, sounds, UI, and the like.

A TPB according to some embodiments of the invention may allow laymen to start planning their application with ease, get required data on specific features, watch sample projects and get cost estimation for the project. These features may be provided by an application simulator that may allow users to connect their project to an app. Accordingly, once they finish planning their product in the component simulator, users can use a system and method according to some embodiments of the invention to run their project with the application simulator, and try to start planning their dedicated app.

According to some embodiments of the invention, an application simulator may include sample projects e.g., physical products that already have (or are associated with) a software application, and users may be provided with access to open their code and see how it was planned An application simulator may use or suggest using, software tools and code parts.

A system according to embodiments of the invention may automatically produce a sample app with an open source code for each selected set of components. This app may be used by a developer to initiate the development, to initially interact with the prototype and/or simulator of the components and to experience the SDK before they start the development.

For example, a system and method according to some embodiments of the invention may include libraries, logic and algorithms for analyzing data coming from potential components (e.g., components included in a product or project), and identify specific gestures and thresholds. For example, using a piezoelectric component might enable responding to different touches (for example, Pet or Hit!), for example, piezoelectric component may return different voltage levels based on different movements. The voltage received from the sensor may be a continuous function, but the identification of the above gestures may be identified by simple algorithms, such as setting a different threshold and/or range to each requested gesture.

A system and method according to some embodiments of the invention may allow users to remain agnostic to low-level hardware functions, and may present only the final result according to default settings in the system.

In the above example, a system according to some embodiments of the invention may include a default threshold value for pet, and a different threshold value for hit. The users may play with the threshold as with other parameters of the embedded logic or algorithms, according to their experience with the simulator. For example, a user may configure logic in a product to be less sensitive or more accurate, and play with the new parameters that they set in the simulator, to sense if the parameters please them. In some embodiments, after choosing the thresholds, the chosen values, logic or algorithms may be automatically updated with an SDK, allowing the software developer to develop the application without the need to develop his own (possibly hardware specific) logic or algorithms.

According to some embodiments of the invention, users may be enabled to order a physical prototype that will suit their preset definitions in a TPB system. The physical prototype may be connected to an application simulator, thus allowing users to evaluate the logic that they set and change them if they are not suitable to their needs. For example, a user may use a system and method according to the invention to plan a smart football. The user may set the physical prototype and certain algorithms for an accelerometer and a GPS component inside the ball.

After ordering the prototype, the user may examine the product and find out that the algorithms that he set in the system are not accurate and may wish to revise the algorithms. A system according to some embodiments of the invention may enable the user to connect the football prototype to a TPB system and use the TPB system to set the algorithms again to match his expectations. For example, the algorithms developed by a software application developer may be included in an SDK, accordingly, all the developer needs to do in order to test new or revised algorithms is load a new SDK and run a test (e.g., a simulation) using a TPB system as described.

According to some embodiments of the invention, default values for various thresholds may be learned based on choices made by users or developers. According to some embodiments of the invention, logic or algorithms generated by a TPB system may change according to data gathered or received from a user. For example, if many users have changed the threshold for recognizing the “Hit gesture” in the example above, and set it to be less sensitive, the system may learn that many users prefer this gesture to be less sensitive, and may change it accordingly. A system and method according to some embodiments of the invention may be connected to analytic systems that analyze end-users of existing products, and may automatically refine algorithms or logic it offers to new users accordingly.

According to some embodiments of the invention, a TPB system may be used from the beginning of the process, as a planning tool for the physical technological product, e.g., when the application is more advanced than the physical product. Some users of the system may enter the system with a “ready-made” application, or at least an idea for the application, and they might want to explore their possibilities for connecting their software application to a physical product.

For example, a software developer might have a game application, and he might want to integrate the game with a physical toy. In such case, an application simulator according to some embodiments of the invention may automatically search for components that fit certain gestures in the application. For example, a TPB system as disclosed may have special algorithms or logic that search for other similar projects, and return the most relevant components for the project. For example, a developer might have special GPS software which identifies locations. The user may use the TPB system to search for physical components that are usually used with GPS systems. According to some embodiments of the invention, a TPB system may scan other projects with similar key-words, and return the mostly used components in similar projects.

According to some embodiments of the invention, a TPB system may enable users without software development knowledge to specify a software application, and use the specifications in order to address different developers. A system and method according to some embodiments of the invention may include one or more of the following tools for drawing and planning the app: pictures importer, animations importer, text-boxes for descriptions, drawing tools, sketching tools, ready-made templates for specification files, the ability to import predefined format files from other development environment, such as the known in the art Flash, Illustrator, Word, Power-Point, and the like.

A system and method according to some embodiments of the invention may enable a user to sync projects from different environments, such as iOS, Android, Windows, Unity, and others, and to sync the application with a planned physical product or prototype (e.g., a virtual product as described).

A system and method according to some embodiments of the invention may enable receiving, from a user, a selection of an OS and run or execute an SDK on, or using, the selected OS. For example, an SDK may be generated, or configured to work with, an OS selected by a user. For example, a user may indicate to a TPB system one of: iOS; Android; and/or a game engines such as: Unity; Corona; Adobe Air and the like and a TPB system may generate or configure an SDK to run, or be executed, on the selected OS or game engine.

Accordingly, a developer can choose his preferred or natural development environment (e.g., using a TPB system as described), e.g., select a target OS, and automatically get, or be provided with, an SDK that is compatible with the selected OS or selected development environment.

A system and method according to some embodiments of the invention may enable receiving from a user a selection of an OS and emulate relevant aspect of the selected OS. For example, a TPB system may generate a simulator engine that may emulate, on a user's device, a selected OS. Accordingly, a user can run his application on his device, using any OS (e.g., Android/iOS/Windows etc.) and a simulation engine provided by a TPB system will interact with the user's application “as if” it was a selected OS.

The advantages and benefits of providing an SDK and a simulation engine to a developer may be obvious to, and appreciated by, one of ordinary skill in the art. For example, since an SDK and simulation engine may be executed, by a software application developer, on his or her own computing device, using any OS or development environment, a software application developer can start developing and testing a software application long before an actual or physical product (or prototype) is available.

Moreover, to start developing an application, a software application developer needs not master any technological fields other than software. Another benefit may be the ability to start a quality assurance (QA) for an application long before a real or physical product is available. For example, testing a software application may be done using and SDK and/or a simulation engine provided by a TPB system without having to use an actual or physical product.

Although a single user or developer is discussed herein, it will be understood that any number of users or developers may use a TPB system, an SDK and/or a simulation engine in parallel or at the same time. For example, in one case, each developer may run, on his or her computer, any one of a TPB system, an SDK and/or a simulation engine using the same virtual product may be stored in a central database and shared by a number of developers. Accordingly, a number of developers can collaborate in developing an application or applications for a product long before a real or actual product is available for testing software applications.

Accordingly, receiving one or more characteristics of a product; automatically selecting, based on the characteristics, one or more physical modules to be included in the product, automatically generating an SDK and providing the SDK and a simulation engine addresses the computer-centric challenge of designing and manufacturing products such as: IOT products; smart or interactive products; etc. As described, the specific computer-related data formats or objects, e.g., the virtual product and the virtual components enable fast and efficient design and testing of products as described as well as quickly moving from design to mass production.

Choosing components may require some level of understanding of the different components and their characteristics. According to some embodiments of the invention, a TPB system may offer to a user an alternative way to develop the technological product by a behaviors simulation.

A system and method according to some embodiments of the invention may include simulating a behavior of a product. According to some embodiments of the invention, a TPB system may receive from a user a collection or set of predefined behaviors. According to some embodiments of the invention, a TPB system may receive a location, in or on a product, the location related to a behavior of the product. Using a behavior and an associated location, a behavior and related events may be simulated by a system and method according to some embodiments of the invention. For example, when a software developer is developing a software application using the SDK which is associated with the disclosed TPB system, the developer can access both the behaviors simulator and the components simulator.

A behavior may be linked by a system and method of the invention with a component. For example, if a user of the disclosed TPB system wants to predict prices or order development kits or go to mass-production or get an accurate functionality simulation, the user may link components to all behaviors. A behavior of a product may be based on, a reaction to, or otherwise related to any one of: an environmental condition (e.g., heat, humidity, noise and the like), a physical condition of the product (e.g., speed, acceleration, orientation in space and the like), an interaction between different physical modules (e.g., an interaction between a heating element and a heat sensor) and an interaction of a user with the product (e.g., moving or touching the product). For example, behaviors may be or may include an application's reaction to a user pressing a toy with a finger on a specific location; a user pressing a toy with a toy with his palm on a specific location; one toy element pressing another toy element.

A behavior may be a reaction to opening or closing a cover, applying force or pressure in a specific spot, a stroking of a toy, a contact made between components of a product, a value or signal produced by a component and so on. Any output produced by a component included in a product may cause or trigger a behavior. For example, a software application designed and developed as described may react (or behave) based on any signal generated by any component included in a product. For example, a behavior of a car seat for children may include sending an alarm to the parent when he's smartphone is far from the car and a weight sensor senses a child on the seat. This example includes a combination of signals gathered from a weight sensor and a communication module but may include other input or output sensors, or combinations of such sensors.

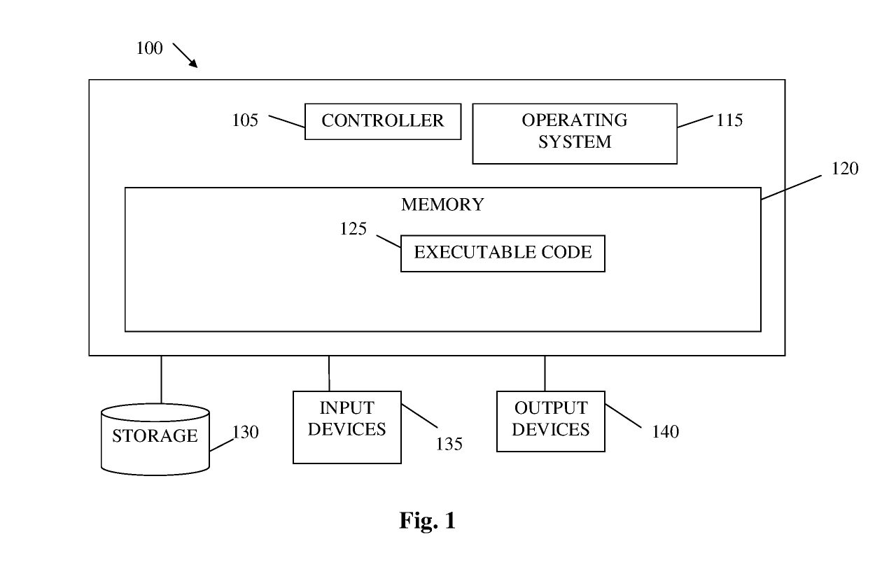

Reference is made to FIG. 1, showing a high level block diagram of an exemplary computing device according to embodiments of the present invention. Computing device 100 may include a controller 105 that may be, for example, a central processing unit processor (CPU), a chip or any suitable computing or computational device, an operating system 115, a memory 120, an executable code 125, a storage 130, input devices 135 and output devices 140. Controller 105 may be configured to carry out methods described herein, and/or to execute or act as the various modules, units, etc. More than one computing device 100 may be included, and one or more computing devices 100 may act as the various components of a system according to embodiments of the invention. For example a TPB system described herein may be, or may include components of, computing device 100. For example, by executing executable code 125 stored in memory 120, controller 105 may be configured to carry out a method of automatically selecting, based on characteristics of a product, one or more physical modules to be included in the product as described herein. For example, controller 105 may be configured to automatically define a and generate a firmware module configured to interface with physical modules in a product and, controller 105 may be configured to use a virtual product to generate a set of manufacturing instructions usable for manufacturing the product, e.g., in a mass production factory.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that selects, based on an idea, concept or characteristics of a product, electrical or other modules to be included in the product as described herein as further described herein. Although, for the sake of clarity, a single item of executable code 125 is shown in FIG. 1, a system according to embodiments of the invention may include a plurality of executable code segments similar to executable code 125 that may be loaded into memory 120 and cause controller 105 to carry out methods described herein. For example, systems, units or modules described herein (e.g., a TPB unit, module or system) may be, or may include, controller 105, memory 120 and executable code 125.

Storage system or device 130 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 130 and may be loaded from storage 130 into memoryl20 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120. Storage system or device 130 may be cloud based as known in the art. In some embodiments, storage 130 may be located remotely from computing device 100, e.g., connected to a server on the internet.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140. For example, a NIC connected to computing device 100 may enable computing device to communicate with other computing devices over a network, e.g., the internet.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, controller, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

According to some embodiments of the invention, a computerized system may create or generate a virtual product. The phrase “virtual product” as used herein may relate to any digital information related to a physical, real or actual product. For example, a virtual product may include, or may be, content in files stored in a database. For example, a virtual product may be stored in a database in storage 130. In some embodiments, a virtual product may include a software or digital representation of the product and of components included in the product. For example, software or digital representation of a product or component may include: digital data sheets of a product and components, drawings of electrical circuits, dimensions and response to input or conditions, e.g., a value or signal produced by an electrical component based on an input value or signal.

Software or digital representation of a product or components may include: definitions or descriptions of behaviors, e.g., a reaction of a bubble level to tilt, a voltage signal level of a heat sensor component as a function of ambient temperature and so on. It will be understood that the phrase “virtual product” is used herein in order to simplify the description and in a non-limiting way. A virtual product may include any information, logic and data required in order to digitally define, represent and simulate a real product as further described herein. A virtual product may include any information, logic and data required in order to mass produce the product, e.g., data included in a virtual product may be used to generate mass manufacturing instructions or specifications as further described herein.

The term “project” as referred to herein may relate to a set of files or other information objects related to a specific virtual product. A project may be, or may include a digital representation of a virtual product, e.g., a project may include a virtual project as described herein. In some cases, a project may be related to more than one product, e.g., a project may be related to a game that includes multiple products, parts or objects. The term “project” as referred to herein may relate to a software project as known in the art, e.g., a project may be, or may include, any information required by a computing system in order to create, modify, process, store, send or otherwise maintain, manage or manipulate a virtual product. For example, data in a project or in a virtual product may be, or may be used to generate or calculate costs of a product or data in a project may be used to simulate a product, define physical, electrical or other aspects of a real product and so on. Accordingly, the terms virtual product and project may refer to the same thing and may be used herein interchangeably.

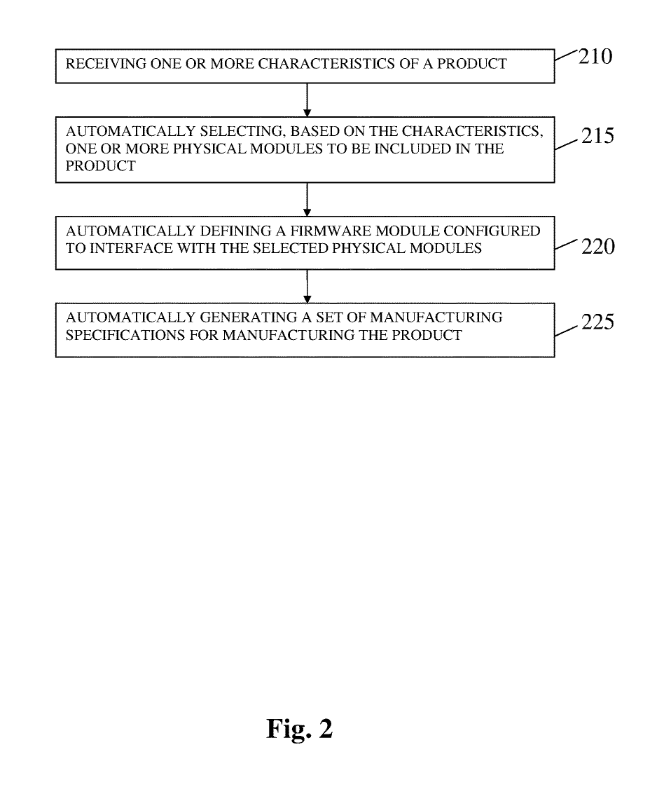

Reference is made to FIG. 2 which shows a flowchart of a method according to an embodiment of the present invention. As shown by block 210, one or more characteristics of a product may be received. For example, a virtual product may be generated based on an idea or concept. In some embodiments, an idea or concept may be, or may include, one or more characteristics of a product. For example, an idea or concept may be: a toy that makes a sound when hugged; a surfboard that automatically suggests the best position for the surfer and so on. An idea or concept may be, or may be included in, one or more digital documents, e.g., in a textual digital file that includes a description of the product.

As shown by block 215, one or more physical modules to be included in the product may be automatically selected, based on the characteristics. For example, in some embodiments of the invention, a digital object (e.g., textual file) that includes characteristics of a product may be examined and components of the product may be selected or suggested based on the characteristics. For example, based on an appearance of the term “acceleration” in an idea or concept, TPB may select a gyro unit to be included in the product. Similarly, a thermometer or heat sensor may be automatically selected based on the word “temperature” in an idea, shutters may be selected based on a phrase such as “open its eyes” and so on.

Accordingly, a system and method may automatically select or suggest components for inclusion in a product based a received idea, concept or characteristic of a product. For example, a database in storage 130 may include definitions of, or references to components. For example, data sheets and other information related to any number of components such as micro switches, LEDs, various sensors and so on may be stored in a database. Metadata may be associated with components in a database. For example, metadata associated with a heat sensor may include terms such as “hot”, “cold” and so on. Accordingly, by analyzing characteristics of an idea, extracting key words and searching for components associated with extracted key words, controller 105 may select components for inclusion in a product based on received characteristics as described.

As shown by block 220, a firmware module configured to interface with the selected physical modules may be automatically defined. A firmware module automatically defined as described herein may further be automatically generated. For example, based on the components selected, a set of device drivers for the selected components may be included in an automatically generated firmware module such that the firmware module is usable as an interface unit for the selected components. For example, device drivers are generally executable code as known in the art and may therefore be stored in storage 130. Accordingly, controller 105 may fetch device drivers for some or all of the components to be included in a product and pack the device drivers in a firmware module that may be executed on a controller included in the product. Controller 105 may further include APIs or other code segments in the firmware module.

According to some embodiments of the invention, an automatically generated firmware module may be modular. For example, in order to save memory and/or increase efficiency, only specific portions, parts or modules may be included in a firmware module generated by a TPB system as described herein. For example, based on the actual modules used by a specific product, modules or code segments may be included in a firmware module generated for the product and other modules or code segments may be excluded from the firmware module, accordingly, the footprint of the firmware code may be reduced to a minimal size and the power consumption of an automatically generated firmware module may be kept as low as possible.

As described, a firmware module may control components in a product, for example, activate components, put components to sleep and so on. Accordingly, by setting values in an automatically generated firmware module or otherwise configuring a firmware module, a TPB system may configure a product according to any criteria or constraint, e.g., a power constraint, a space constraint and so on.

For example, various parameters and settings may be automatically set (e.g., by a TPB system when generating a firmware module) based on user requirements. For example, based on a characteristic of a product or based on user input, a TPB system may generate a firmware module with specific power saving settings, e.g., how often a device or component goes to sleep, how long to advertise a Bluetooth low energy and so on. For example, if the user indicates that power saving is desired then strict criteria may be used. In another case, a TPB system may receive from a user the time that a product is to operate without recharging its battery, the TPB may calculate the total power consumption (e.g., by summing the power consumption of all components in the product), determine the time the product can operate based on the batteries included and may indicate to the user whether or not the product can actually operate, without recharging the batteries, as requested. Based on the required operating time, power consumption and power source available, a TPB system may apply, by setting values in an automatically generated firmware module, power saving parameters. For example, to extend the operational time of a product, sleep time, blinking LEDs and other power related or consuming operations of a product may be altered.

Any content may be included in a firmware module, e.g., a TPB system may include pictures, images, data files, audio files and content in a firmware module. For example, a user may indicate, or point to content to be included in firmware that is in turn included in a product, e.g., firmware included in a firmware module described herein. For example, a user may want a specific tune to be played when a warning is sounded by a device, to achieve that, the user may point to, or select, an audio file and a TPB system may include the selected audio file in a firmware module and further configure the firmware module to play the selected file when sounding a warning (e.g., send the audio file to a speaker included in the product). Accordingly, a modular firmware module generated for a product may be automatically generated using specific modules or content based on criteria or rules that may be automatically applied by a TPB system and/or the automatically generated modular firmware module may be created based on input or requirements received from a user.

As shown by block 225, a set of manufacturing specifications for manufacturing the product may be generated. Manufacturing specifications as referred to herein may include any data or information needed, required or used by a factory or other manufacturer in order to manufacture a product. For example, aspects related to mass producing a product such as: dimensions; type of materials; number and size of coating or other layers; assembly order or procedures; a temperature and the like may all be included in manufacturing specifications or instructions produced by a system and method as described herein. For example, manufacturing specifications or instructions may be generated based on metadata or other data of components selected for a product (e.g., metadata included in, or associated with virtual components). For example, based in a power consumption and/or optimal working temperature of a component in a product, a TPM system may generate manufacturing specifications that include proper wiring and cooling vents. The phrases “manufacturing instructions” and “manufacturing specifications” as used herein may refer to the same thing and may be used herein interchangeably.

For example, a system and method according to embodiments of the invention may automatically generate a set of manufacturing instructions, the manufacturing instructions usable for manufacturing a product that includes the selected physical modules and the firmware module. For example, some standards for production files are known in the mass production industry and a system and method may generate a production file or instruction set based on a standard, protocol or convention. For example, a set of production instruction may be readily used by a factory in order to mass produce a product.

Accordingly, a system and method according to embodiments of the invention address the challenge of enabling a non-professional to design and manufacture a product based on an idea or concept. For example and as described, a system and method according to embodiments of the invention receives a digital (or software) representation of a product and stores the digital representation in a virtual product, e.g., in a project as described. For example, an image and dimensions of a surfboard or toy may be received, e.g., from a non-professional who wants to design and mass produce a new type of surfboard or toy. For example, an image of a product and a set of numerical values representing dimensions of the product may be received from a user and used to create a new virtual product. As described, components may then be added to, or included in the virtual product.

A system and method according to embodiments of the invention may store characteristics of components in a database, e.g., in the form of digital files that include data sheets, descriptions of a component (e.g., digital images) and the like, selects some of the stored components based on an idea for a product, and includes the selected components in a virtual product. For example, a digital object (e.g., file or set of files) that includes or represents the virtual product is made to include or reference one or more files that represent components and/or characteristics of the components; accordingly, the virtual product is caused, or made to, include the selected components. As described, components may be automatically selected for inclusion by a computerized system based on analysis of an idea.

Enabling a non-professional to design and mass manufacture a product is addressed by some systems and methods according to embodiments of the invention by automatically generating instructions usable for mass producing a firmware module to be included in a product, the firmware module usable for controlling or interfacing real or physical components included in a real product that is produced based on a virtual product as described. For example, a TPB may examine the list of components included in a virtual product and identify the components, find (e.g., in storage 130) software device drivers, software libraries or other software usable to control, interact or interface with the selected components, and include the software in a virtual product and/or in a project.

Based on the software required for controlling or interfacing components included in a product, TPB may calculate or define a firmware module. For example, the size of memory in a firmware unit may be calculated based on the sizes of the components in the product. A TPB system may automatically define, set or determine the number and/or type of pins or wires in a firmware unit. For example, based on the number and/or type of components selected for inclusion in a product, a TPB system may define hardware and software attributes, aspects or characteristics of a firmware module included in a product. Based on a definition of a firmware module, a TPB system may generate a set of instructions for mass manufacturing the firmware module.

Once a definition of a firmware module is known, generating instructions for mass manufacturing the firmware module is known in the art. After automatically defining a firmware module as described, a TPB system may generate manufacturing instructions for the firmware module based on any system or methods, protocol, format or standard as known in the art. In some embodiments, a single set of manufacturing instructions includes the manufacturing instructions for the product and the manufacturing instructions for the firmware module such that a real, actual or physical product that is mass manufactured includes the firmware module. For example, in some embodiments, a set of manufacturing instructions for a product includes manufacturing instructions for all of: the product's body or chassis, physical components installed on the product's body or chassis, a firmware module installed on the product's body or chassis and wiring connecting the firmware module and the components.

According to some embodiments of the invention, a unique identification value or code may be embedded in each physical or real firmware module included in each respective physical or real product manufactured. Code in the firmware unit may enable examining, retrieving or sending the unique identification value or code. Code or logic in the firmware unit may be configured to operate based on the unique identification value. For example, some operations, service or requests may be allowed or denied based on an identification code. In other cases, a unique identification value or code may be used in order to identify products, communicate with products and so on.

Some systems and methods according to embodiments of the invention provide a graphical user interface (GUI) tool that may be used to graphically add physical modules or components to product; remove a physical modules or components from a product; position physical modules or components in, or on a product, or otherwise define or set aspects related to components included in a product. For example, based on a set of components in a database, graphical representations of components may be displayed on a display of a computer, e.g., images of the components and a textual description may be displayed. In some embodiments, both the product and a set of components may be displayed, e.g., side by side, and a system and method may enable a user to include a component in the product using drag and drop as known in the art. For example, a TPB system may display an image of a toy being designed and further display a set of components (e.g., micro switches that can sense touch) on a display screen. To cause the toy to sense a pat on the back, a user may drag a component (e.g., a micro switch) and drop or place the component on the toy's back. Based on an addition of a component to a product (e.g., a drag and drop operation of a user as described), a TPB system may update a virtual product such that it includes the component. Including a component may include indicating, e.g., in a virtual product, a location of the component, an orientation of the product or any other parameter, value or attribute related to the inclusion of a real or physical component in a real or physical product. For example, a user may move or rotate a component on or in a product to define how the component will be physically connected to, or installed in, a product.

According to some embodiments, a simulation engine (e.g., included in a TPB system) may be configured to simulate a product. For example, a virtual product that includes components as described herein may be simulated by a computerized system. In some embodiments, a TPB system may use a virtual product in order to simulate a usage, behavior, reaction or any other aspect of a real or actual product. A simulation engine may simulate various aspects or elements that are relevant or related to a real product. For example, a simulation engine may simulate an output from a physical module, an environmental condition, a physical condition of a product, an interaction between different physical modules in a product and an interaction of a user with the product. Accordingly, a simulation engine may simulate a behavior of a product in various conditions, including a reaction to an environment, e.g., a reaction to touch, heat, speed, humidity, sound, orientation, tilt, acceleration and so on.

According to some embodiments, a simulation engine (e.g., included in a TPB system) may be configured to simulate an interaction of a product with external elements or systems. For example, a TPB system may simulate an interaction of a product with any one of a smartphone, a tablet computer, a smart television, a home computer (PC), virtual reality devices (e.g., VR Glasses) etc. According to some embodiments, a simulation engine (e.g., included in a TPB system) may be configured to simulate an interaction of a product with an application executed on any device or system. Generally, a TPB system may emulate any system or device as known in the art and using a virtual product, may simulate an interaction of a product with any system or device. For example, a TPB system may emulate or simulate any functionality or other aspect of an SDK, firmware and components in a product and may therefore simulate any interaction of the product with an emulated system or device, e.g., by communicating any data or information, e.g., outputs and inputs, between the product and an external device or system.

For example, a virtual product that includes components as described herein may include any information or data required in order to simulate the product and components. As described, a digital representation of a product and its components may be objects that include data and logic usable to simulate the product and components. For example, a virtual product may include a digital representation of a surfboard that includes any data or logic needed in order to present an image of the surfboard on a display of a computer and the digital representation may further be used by a computer in order to rotate, tilt or otherwise manipulate the image on the display, e.g., such that a 3D view of the surfboard is provided. As described, a software or digital representation of components (e.g., virtual components as described herein) may include any data or logic required for simulating the components. For example, a virtual component may be used in order to simulate an output of a component based on an input as known in the art.

Accordingly, using a virtual product as described, a simulation engine may simulate, and display or otherwise provide a simulation of, a product or a behavior of a product. A simulation of a product and/or a simulation of a product's behavior as referred to herein, may be, or may include, an interactive simulation as known in the art. For example, a simulation engine may provide a GUI tool usable by a user to define or provide input and see the results or reactions to the input. For example, a virtual product related to a surfboard that includes a level sensor and an acceleration sensor may be displayed and GUI buttons or slides may enable a user to set or define a tilt of the surfboard and/or an acceleration of the surfboard. Based on user input, a simulation engine may tilt a 3D image of the surfboard on a display, provide a virtual level sensor component in the virtual product with a signal representing the tilt, read or calculate an output from the virtual level sensor and display the output to a user. For example, a tilt may be presented numerically, e.g., as a value on the screen or it may be presented by a virtual component. For example, an image of a bubble level component may be shown on the surfboard and the bubble may be shown at, or moved to, a location that reflects the tilt received from the user. Accordingly, simulating a product as described herein includes receiving input from a user, the input including, representing, or related to, any one of: a usage of a product; a condition or state of the product; a location of a product; a position of the product; an environmental condition; an interaction between different physical modules included in the product and an interaction of a user with the product.

Simulating a behavior of a product may include graphically presenting, in real-time, input and/or output data of physical modules. The term “real-time” (also known in the art as “realtime”, or “real time”) as referred to herein generally relates to processing or handling of input or events at the rate or pace that the input is received, or the events occur or detected. For example, a simulation according to embodiments of the invention may include receiving input and graphically presenting output of a sensor included in a simulated product within milliseconds or other very brief periods so that the output is visible virtually immediately.

Addressing, by embodiments of the invention, the challenge of enabling a non-professional to design and mass or otherwise manufacture a product based on an idea or concept may include automatically generating an SDK. For example, based on an automatically defined and generated firmware module, a TPB system may automatically define and create or generate an SDK that can be readily used (e.g., by a software application developer) in order to communicate with the firmware module and thus control, or communicate with, components in a real product. For example, an SDK specifically tailored and created for a specific firmware module may enable a programmer to send or provide input or commands to components installed in a product and/or receive readings or other output from components in a product. For example, an SDK created by a TPB system for a specific product is configured to interact with a firmware module in the product and thus enables a programmer to use the SDK in order to send commands to components via the firmware module. For example, an SDK may be automatically generated by a TPB system based on attributes or definitions of a firmware module, e.g., based on the functions or operations supported by the firmware module, based on the physical components connected to the firmware module and so on. Since, in some embodiments, a TPB system defines the firmware module, any information required for generating an SDK may be available to the TPB system.

As known in the art, selecting electrical or other components for a product may require comparing a number of relevant or potential components, e.g., comparing or evaluating aspects, characteristics or other attributes such as cost, efficiency and size. According to some embodiments of the invention, a system and method may select, based on an idea, concept or characteristics of a product, at least two different alternative sets of physical components, units or modules to be included in the product. For example, if a heat sensor is included in a product, a TPB system may scan a database in storage system 130 and may find three different heat sensors. A system and method according to some embodiments may generate a number of alternative designs for a product based on a respective number alternative of sets of components. For example, three different designs (and manufacturing instructions) may be generated based on three different heat sensors selected as described herein. Generally, a design of a product may be as known in the art, e.g., a design may include any definition of the product or any other data usable or required for manufacturing the product.

Alternative designs may be ranked or scored based on any input, criteria, rule or logic. For example, a number of designs of a product that differ by the components included in then may be ranked or scored based on a total manufacturing cost of the product or based on a bill of material (BOM) cost. A ranking or scoring of designs may be related to time. For example, metadata of components in database 130 may include the delivery time or availability of the components, accordingly, a TPM system may calculate the time it may take to obtain or receive components and may thus calculate a time for manufacturing a product based on a specific design or a specific set of components. Ranking, scoring and sorting designs or sets of components may be according to a criterion received from a user. For example, if a user is only interested in quality and does not care about costs, a design that includes the set of components with the highest quality (and possibly, not the lowest costs) may be ranked highest or placed at a top of a list of designs or component sets shown to a user. In some embodiments, a set of criteria may be used in order to rank, score or sort designs or sets of components. For example, two or weights may be associated with each component in a design or set of components based on two or more criteria. A scoring of a set of components or design may then be calculated based on the weights, e.g., as known in the art.

In the specific case of cost, a system and method may calculate a production cost for a product based on the selected physical modules. For example, metadata of components in a database may include costs or prices of components and a TPM system may sum up the costs of all components included in a virtual product, add the cost of a chassis or other element and thus generate a cost, or cost estimation for production.

As described, a TPB system may receive a selection of components from a user and include the selected components in a product. For example, virtual components may be graphically selected by a user and included in a product. A system and method according to embodiments of the invention may automatically identify a redundant component included in a product. A system and method according to embodiments of the invention may automatically identify a component missing in a product. For example, if a user selects a LED to be included in a product but forgets or fails to include a power source (e.g., battery) to activate the LED then a TPB system may generate an alert or indication informing the user that a power source is missing. In another case, a user may include two RFID components and connect the two RFID to two antennas, in such case, since one antenna can serve the two RFID components, a TPB may alert the user that one of the antennas is redundant.

In some cases, in order to identify redundant or missing components, a system and method according to embodiments of the invention may analyze a product and all included components using any information related to the product and components. For example, if data in a virtual component included in a product indicates that the component needs a power source then a TPB system may verify that a power source is included in the product. Upon detecting, identifying or determining that a component is missing in a product, a system and method may automatically select the missing component for inclusion in a product. Accordingly, a system and method may automatically select a component to be included in a product based on a set of components already included in a product. Otherwise described, a system and method according to embodiments of the invention may determine, define or receive, an initial set of components included in a product and may automatically select, based on the initial set of components, an additional component to be included in the product.

A system and method according to embodiments of the invention may verify interoperability and/or proper connections of components in a product. For example, a TPB system may verify that a LED included in a product is connected to a power source.

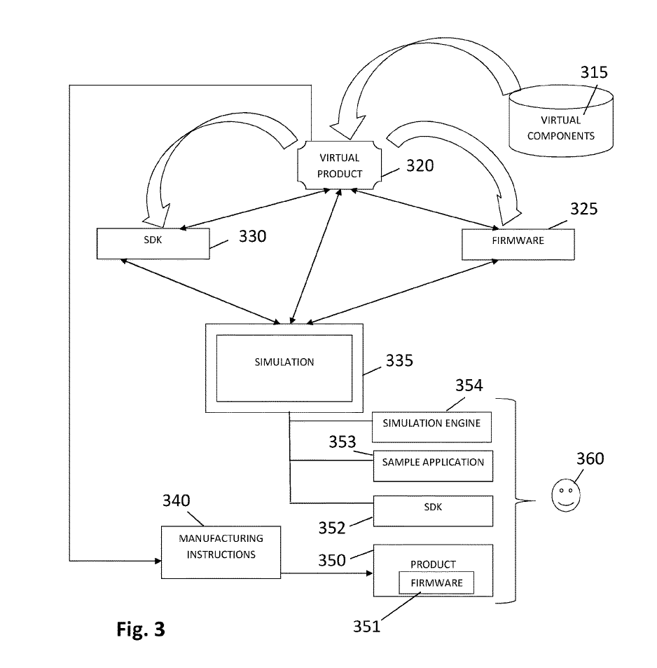

Reference is made to FIG. 3 which shows a flow and components of a system according to an embodiment of the present invention. As shown, virtual components 315 stored in a database may be added to a virtual product 320. For example, a database in storage 130 may include virtual components 325 and one or more virtual products as described. Virtual components 315 may be graphically presented to a user and the user may add virtual components by dragging them into or onto virtual product 320, e.g., using drag and drop techniques as known in the art. As shown, based on a virtual product (and virtual components included therein), an SDK 330 and a firmware module 325 may be generated and/or defined. For example, an SDK usable to communicate or interface with components in a product may be generated based on a virtual product as described. Similarly, based on data in a virtual product, a firmware module may be defined and/or generated as described. As shown, a simulation 335 may simulate a product. For example, by interacting with a virtual product (e.g., using an SDK and/or code in a firmware unit), a TPB system may simulate a behavior of a product. A simulation may include manipulating a virtual product (e.g., to simulate movement, tilt, heat and so on). A simulation may include interacting or communicating with virtual components. For example, a simulation may include resetting components, providing values and so on. As shown by block 340, manufacturing instructions may be generated and provided. For example, manufacturing instructions 340 may be usable by a factory to mass produce a product represented by virtual product 320.

As shown, a user 360 may be provided with a real or physical product 350 that may include firmware 351, an SDK 352, a sample application 353 and a simulation engine 354. For example, real or physical product 350 that includes firmware 351 may be manufactured by a factory based on manufacturing instructions generated by a TPB system as described. SDK 352 may be generated by a TPB system as described. For example, generated based on a specific product, SDK 352 may be a specifically tailored SDK suitable for interfacing an application with a specific product and the firmware included in the product. Sample application 353 may be an application that enables a user to start developing an application (e.g., when used as a starting point), see exemplary code etc. For example, if the product includes a LED then sample application 353 may include a button for switching the LED on and off Simulation engine 354 may be software enabling a user to simulate a product. Simulation engine may be connected to product 350 and may communicate with firmware 351 to thus simulate any aspect of the real product 350. Accordingly, a system and method of the invention may enable a user that has no knowledge in hardware to develop a smart product that includes hardware components.

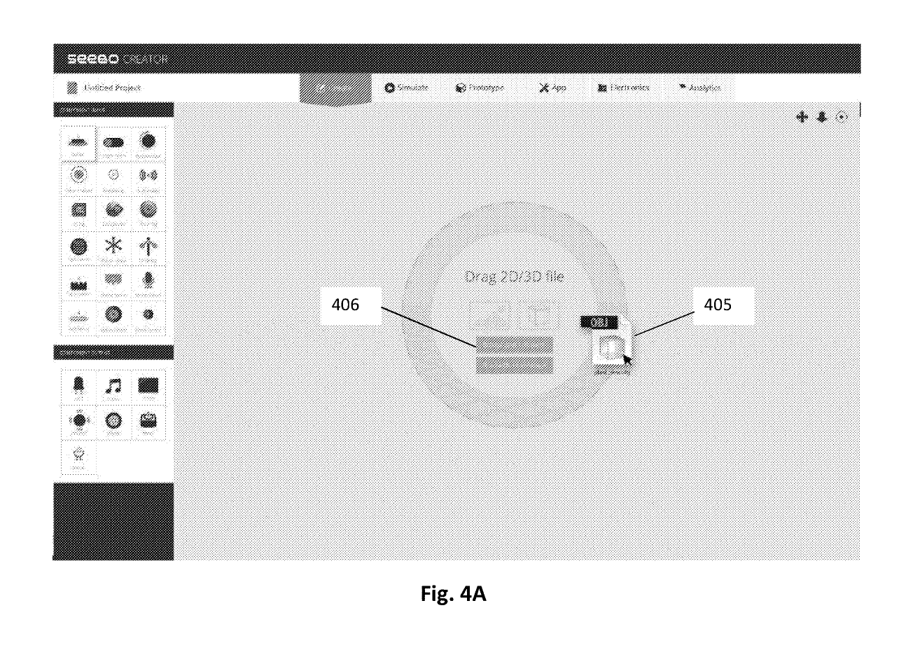

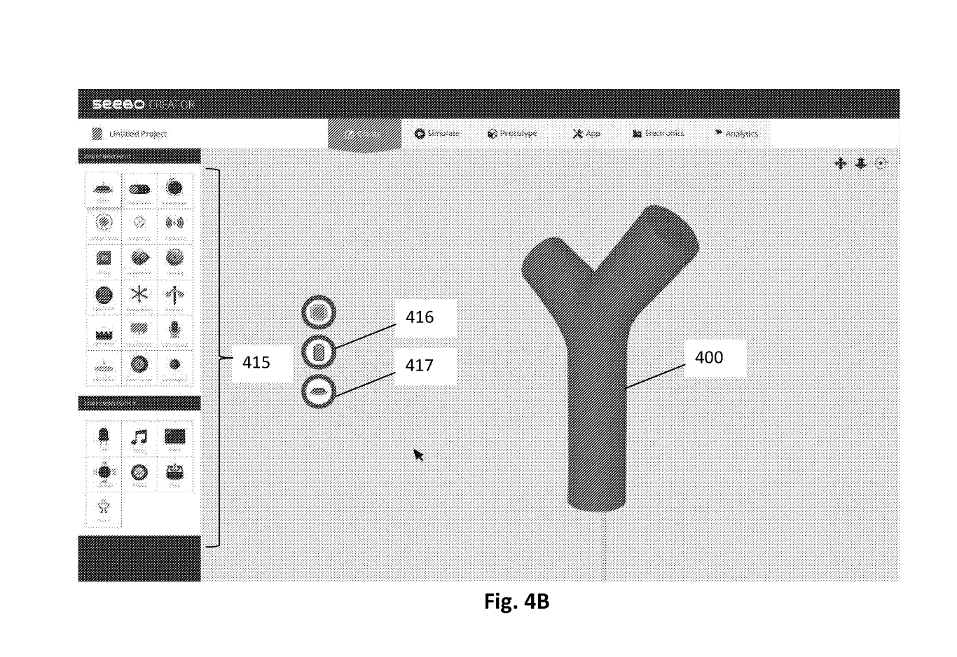

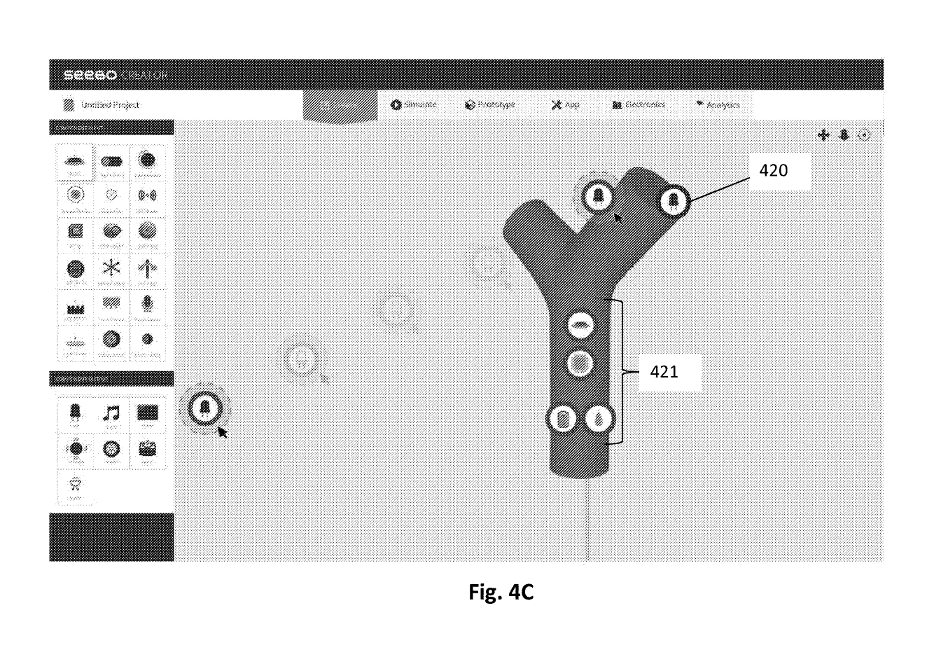

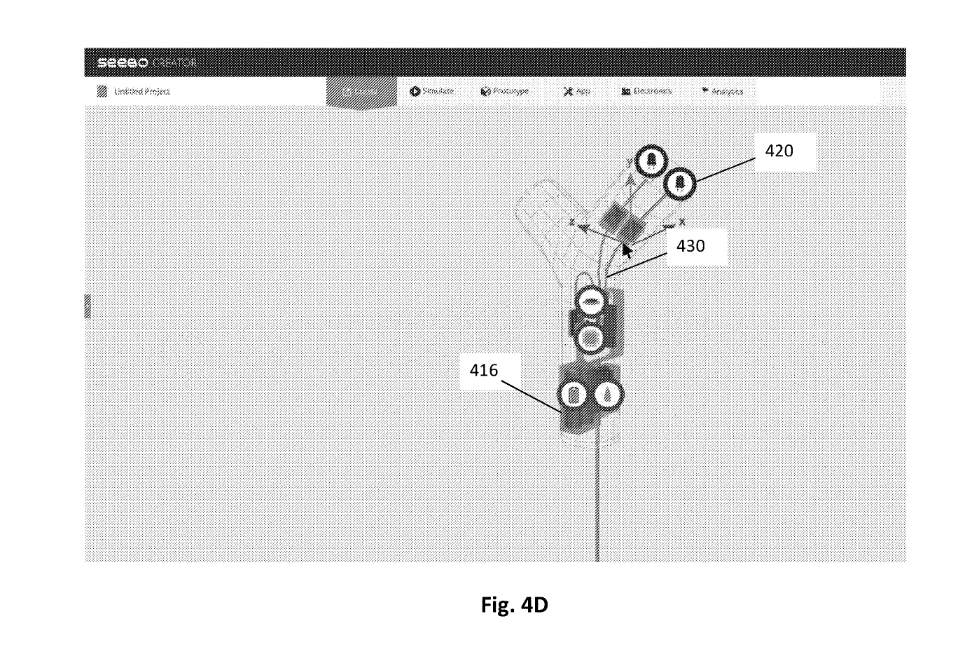

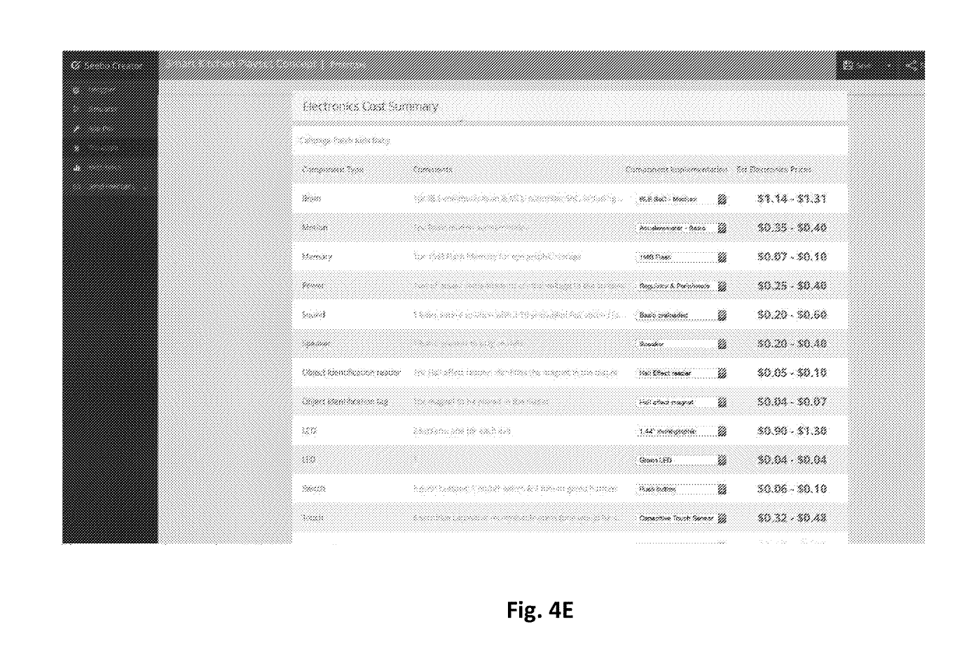

Reference is now made to FIGS. 4A, 4B, 4C and 4E which are exemplary screenshots according to embodiments of the invention. For example, the screenshots shown in FIGS. 4A-4E may be screens presented to a user by a TPB system described herein. As shown by block 405 in FIG. 4A, a TPB system may enable a user to drag an image of a product into a design screen. As shown by block 406 in FIG. 4A, a TPB system may enable a user to select an image of a product from a computer, or upload an image of a product to a server. As described, an image or object such as the one shown by block 405 may be used to initialize a virtual product.

As shown by block 415 in FIG. 4B, a set of components may be presented to a user and the user may select components to be included in a product. For example and as shown by battery 416 and button 417 in FIG. 4B, the user may select a battery and on/off button to be included in product 400. FIG. 4C exemplifies a drag and drop technique that may be used for adding components, units or modules to a product according to some embodiments of the invention. For example, LED 420 may be dragged (as shown in FIG. 4C) from the set of components 415 and placed on product 400. It is noted that a component may not merely be included in a product but that embodiments of the invention allow a user to graphically locate a component in, or on, a product, at the exact desired location, in a desired orientation. For example, each of the components shown by blocks 421 may have been placed by a user on product 400 where the user wants these components. Since as described, manufacturing specifications for manufacturing a real product may be generated based on virtual product 400, when manufactured, the real product may include components 421 and 420 right where shown on virtual product 400.

As shown by wiring 430 in FIG. 4D, components may be automatically connected by a system and method according to some embodiments of the invention. For example and as shown, a TPB system may automatically connect battery 416 to LED 420. For example, logic in a TPB system may analyze components, determine that a first component (e.g., LED 420) requires electric power, determine that a second component (e.g., battery 416) is a power source and therefore connect the first and second components using a proper connection medium, e.g., an electric wire that may be selected based on the power consumption of LED 420.

As shown by FIG. 4E, a list of components and their cost may be presented to a user. As shown, a range of costs or prices for each component may be presented and a user may select the components based on their price. Accordingly, a user may quickly and easily estimate the cost of a product, e.g., the cost of each component, the total cost and so on.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A computer-implemented method comprising:
receiving one or more characteristics of a product;
automatically selecting, based on the characteristics, one or more physical modules to be included in the product;
automatically generating a set of manufacturing specifications, the manufacturing specifications usable for manufacturing the product, wherein the product includes the selected physical modules.

2. The method of claim 1, comprising:
automatically generating specifications of a firmware module configured to interface with the selected physical modules;
wherein the manufacturing specifications are usable for embedding, in the product, a firmware module based on the specifications.

3. The method of claim 1, comprising generating a software development kit (SDK) module configured to interface with the firmware module, the SDK module usable by an application developer for developing a software application for the product.

4. The method of claim 1, comprising providing a graphical user interface (GUI) that enables a user to graphically perform at least one of: add a physical module to the product, remove a physical module from the product and position a physical module on the product.

5. The method of claim 1, comprising:
providing a simulation engine configured to simulate at least one of: an input to the selected physical modules, an output from the selected physical module, an environmental condition, a physical condition of the product, an interaction between different physical modules and an interaction of a user with the product; and
using the simulator engine to simulate a behavior of the product.

6. The method of claim 5, comprising, while simulating a behavior of the product, graphically presenting input or output data of the physical modules.

7. The method of claim 1, comprising:
selecting, based on the characteristics, at least two different alternative sets of physical modules to be included in the product;
generating at least two alternative designs for the product based on the selected sets; and
ranking the at least two designs based on a set of criteria.

8. The method of claim 1, comprising calculating a production cost for the product based on the selected physical modules.

9. The method of claim 1, comprising embedding a unique identification value in each firmware module included in each respective manufactured product.

10. The method of claim 1, comprising selecting, based on the characteristics, an initial set of components to be included in the product and automatically selecting, based on the selected set, an additional component to be included in the product.

11. A system comprising:
a memory; and
a controller, the controller configured to:
receive one or more characteristics of a product,
automatically select, based on the characteristics, one or more physical modules to be included in the product, and
automatically generate a set of manufacturing specifications, the manufacturing specifications usable for manufacturing the product, wherein the product includes the selected physical modules.

12. The system of claim 11, wherein the controller is configured to:
automatically generate specifications of a firmware module configured to interface with the selected physical modules;
wherein the manufacturing specifications are usable for embedding, in the product, a firmware module based on the specifications.

13. The system of claim 11, wherein the controller is configured to generate a software development kit (SDK) module configured to interface with the firmware module, the SDK module usable by an application developer for developing a software application for the product.

14. The system of claim 11, wherein the controller is configured to provide a graphical user interface (GUI) that enables a user to graphically perform at least one of: add a physical module to the product, remove a physical module from the product and position a physical module on the product.

15. The system of claim 11, wherein the controller is configured to:
execute a simulation engine configured to simulate at least one of: an input to the selected physical modules, an output from the selected physical module, an environmental condition, a physical condition of the product, an interaction between different physical modules and an interaction of a user with the product; and
use the simulator engine to simulate a behavior of the product.

16. The system of claim 15, wherein the controller is configured to, while simulating a behavior of the product, graphically present input or output data of the physical modules.

17. The system of claim 11, wherein the controller is configured to:
select, based on the characteristics, at least two different alternative sets of physical modules to be included in the product;
generate at least two alternative designs for the product based on the selected sets; and
rank the at least two designs based on a set of criteria.

18. The system of claim 11, wherein the controller is configured to calculate a production cost for the product based on the selected physical modules.

19. The system of claim 11, wherein the controller is configured to embed a unique identification value in each firmware module included in each respective manufactured product.

20. The system of claim 11, wherein the controller is configured to select, based on the characteristics, an initial set of components to be included in the product and automatically select, based on the selected set, an additional component to be included in the product.
